(19) United States
(12) Patent Application Publication
(10) Pub. No.: US 2019/0111434 A1
(43) Pub. Date: Apr. 18, 2019

(54) SMARTBOX AND USES THEREOF

(71) Applicant: THE FEINSTEIN INSTITUTE FOR MEDICAL RESEARCH, Manhasset, NY (US)

(72) Inventors: Mike Eller, Sayville, NY (US); Ross Schneidman, Plainview, NY (US); Chris Zavala, Dix Hills, NY (US); Brian Torpey, Northborough, MA (US)

(73) Assignee: THE FEINSTEIN INSTITUTE FOR MEDICAL RESEARCH, Manhasset, NY (US)

(21) Appl. No.: 16/159,825

(22) Filed: Oct. 15, 2018

Related U.S. Application Data
(60) Provisional application No. 62/572,693, filed on Oct. 16, 2017.

(51) Int. Cl. B01L 3/00; G06F 9/54

(52) U.S. Cl. CPC B01L 3/545; B01L 2300/023; B01L 2300/021; G06F 9/542

(57) ABSTRACT

Systems, devices and methods are disclosed for collecting laboratory specimens from laboratory specimen boxes once a specimen has been placed inside a box.

### CROSS-REFERENCE TO RELATED APPLICATION

This application claims the benefit of U.S. Provisional Patent Application No. 62/572,693, filed Oct. 16, 2017, the contents of which are herein incorporated by reference.

### BACKGROUND OF THE INVENTION

Laboratory boxes are used across geographies to hold lab specimens for collection. Couriers affiliated with collection services travel to pick up the samples. Currently, clients call the service department in order to schedule a pick up. However, there can be a large number of “dead stops” in which a scheduled route pickup results in no specimen, due to the client not having left a sample in the container. This results in wasted “full time employee” (FTE) hours. For a health system with approximately 5,000 laboratory specimen boxes, this could result in unnecessary expenses of approximately $650,000 a year.

### SUMMARY OF THE INVENTION

The invention provides a SmartBox that alerts laboratory logistics centers when a sample is placed in a specimen box, in order to reduce wasted courier hours on “dead stops” in which no specimen has been placed for pick up.

### DETAILED DESCRIPTION OF THE INVENTION

The invention provides a laboratory specimen box (SmartBox) that will automatically let a centralized logistics server know that a lab sample has been placed inside the box, signaling the need for a pick-up. The server or the laboratory logistics center team monitoring the SmartBox alerts can then allocate pick-up responsibility to a driver on a fixed route or deploy a driver specially to service the alerting SmartBox. The SmartBox alert system will allow decreased pick-up turnaround time and increased client/patient satisfaction.

The laboratory specimen box (SmartBox) can be made of durable, all weather plastic or metal, which houses a detection system, such as scale or light beam system or other mechanism for detection of an object placed in the box, a battery pack or other energy producing medium (e.g., solar), and an interface connection, which allows communication with a specimen collection service via cable, wifi, cellular or other medium. Every box can be integrated into a centralized logistics platform software, connected, e.g., by Verizon 4G or 5G service. The basic premise of the box is to alert a centralized logistics team that a specimen has been placed inside.

Accordingly, the invention provides a laboratory specimen box comprising
a detection system to detect a laboratory specimen placed inside the box,
an interface connection system connected to the detection system and to an internet, and
a battery or power source to power the interface connection system and optionally the detection system, wherein the detection system is configured to alert a specimen collection service via the interface connection system when a laboratory specimen is placed inside the box.

The detection system can comprise, for example, one or more of a scale system, an optical detection system, a light beam, a bar code reader for reading a bar code on the laboratory specimen, and a push button. The detection system can be activated, e.g., by closure of the box once the specimen is placed inside and/or by pushing a push button.

The specimen box can include a locking and unlocking system, which can optionally be activated remotely.

Each specimen box can be configured with a unique identifier or barcode.

Each specimen box can include a microprocessor.

The specimen box can include a temperature sensor to monitor the temperature inside the box, which if too high, or too low, can affect the integrity of the specimen. The specimen box can include a heating and/or cooling system. For example, the box can include electric heat and/or cooling and a fan. The specimen box can include an electronic security monitoring system and/or a GPS locator. The laboratory box can also include, e.g., a sensor to report the state of charge of the battery, and/or a sensor to indicate that the box is in the correct orientation.

The interface connection system can comprise a wireless modem.

The invention also provides a system for collecting laboratory specimens from laboratory specimen boxes, the system comprising a plurality of the laboratory specimen boxes disclosed herein connected via an internet to a specimen collection service, wherein each individual specimen box is identified within the system and wherein the system is configured to notify the collection service when a laboratory specimen is placed inside a specified box.

The system can comprise one or more microprocessors, a hard-wired and/or wireless connection to each laboratory specimen box within the system, and a communication device to dispatch a courier to collect a laboratory specimen from a laboratory specimen box once the specimen has been placed in the box. The system can automatically communicate with a courier who is closest to the specimen box and/or the system can include personnel who notify the courier.

The laboratory box can also provide the system with, e.g., a signal regarding the state of charge of the battery, a signal that the box is ready to receive a laboratory specimen, a signal indicating the box is closed, a signal indicating that the box is open, a signal indicating that the box is full and cannot hold any additional sample, a signal indicating the temperature inside and/or outside the box, a signal that the laboratory specimen has been removed from the box, and/or a signal that the laboratory box has been knocked on its side or upside down, compromising the specimens.

The invention further provides a method for collecting laboratory specimens from laboratory specimen boxes, the method comprising receiving a notification from the system disclosed herein that a laboratory specimen has been placed within a specified specimen box and dispatching a courier to collect the laboratory specimen from the specimen box.

All combinations of the various elements described herein are within the scope of the invention unless otherwise indicated herein or otherwise clearly contradicted by context.

1. A laboratory specimen box comprising
a detection system to detect a laboratory specimen placed inside the box,
an interface connection system connected to the detection system and to an internet, and
a battery or power source to power the interface connection system and optionally the detection system, wherein the detection system is configured to alert a specimen collection service via the interface connection system when a laboratory specimen is placed inside the box.

2. The box of claim 1, wherein the box is constructed of plastic or metal.

3. The box of claim 1, wherein the detection system comprises one or more of a scale system, an optical detection system, a light beam, a bar code reader for reading a bar code on the laboratory specimen, and a push button.

4. A system for collecting laboratory specimens from laboratory specimen boxes, the system comprising a plurality of the laboratory specimen boxes of claim 1 connected via an internet to a specimen collection service, wherein each individual specimen box is identified within the system and wherein the system is configured to notify the collection service when a laboratory specimen is placed inside a specified box.

5. A method for collecting laboratory specimens from laboratory specimen boxes, the method comprising receiving a notification from the system of claim 5 that a laboratory specimen has been placed within a specified specimen box and dispatching a courier to collect the laboratory specimen from the specimen box.
